(19) United States
(12) Patent Application Publication
(10) Pub. No.: US 2021/0334709 A1
(43) Pub. Date: Oct. 28, 2021

(54) BREADTH-FIRST, DEPTH-NEXT TRAINING OF COGNITIVE MODELS BASED ON DECISION TREES

(71) Applicant: INTERNATIONAL BUSINESS MACHINES CORPORATION, ARMONK, NY (US)

(72) Inventors: Nikolas Ioannou, Zurich (CH); Andreea Anghel, Adliswil (CH); Thomas Parnell, Zürich (CH); Nikolaos Papandreou, Thalwil (CH); Charalampos Pozidis, Thalwil (CH)

(21) Appl. No.: 16/858,900

(22) Filed: Apr. 27, 2020

(51) Int. Cl. G06N 20/20; G06N 3/00; G06N 5/00

(52) U.S. Cl. CPC G06N 20/20; G06N 5/003; G06N 3/006

(57) ABSTRACT

The present invention is notably directed to a computer-implemented method of training a cognitive model. The cognitive model includes decision trees as base learners. The method is performed using processing means to which a given cache memory is connected, so as to train the cognitive model based on training examples of a training dataset. The cognitive model is trained by running a hybrid tree building algorithm, so as to construct the decision trees and thereby associate the training examples to leaf nodes of the constructed decision trees, respectively. The hybrid tree building algorithm involves a first routine and a second routine. Each routine is designed to access the cache memory upon execution. The first routine involves a breadth-first search tree builder, while the second routine involves a depth-first search tree builder.

### BACKGROUND

The present invention relates in general to techniques of training cognitive models that rely on decision trees as base learners. In particular, the present invention is directed to methods combining breadth-first search and depth-first search tree builders.

Random forest (RF) models are foremost tools for machine learning (ML). They are used in multiple applications, including bioinformatics, climate change modelling, and credit card fraud detection. A RF model is an ensemble model that uses decision trees as base learners. RF models are amenable to high degree of parallelism, typically tend to have good generalization capabilities, natively support both numeric and categorical data, and allow interpretability of the results. Designing a scalable and fast decision-tree-building algorithm is key for improving performance of RF models and, more generally, cognitive models that use decision trees as base learners, notably in terms of training time.

The performance in training time obtained depends on the manner in which the tree is built, starting with the order in which the nodes are created/traversed. One well-known approach is the so-called depth-first-search (DFS) algorithm. In DFS, after a node has been split, the tree-building algorithm starts at a root node and explores as deeply as possible along each path before backtracking and exploring other paths. If, for example, the left children nodes are chosen before the right children nodes, the algorithm starts at the root node and recursively selects the left child first at each depth level. Once a terminal node has been reached, it traverses up recursively until an unexplored right-hand-side child is encountered. A DFS-based RF tree-building algorithm is notably available in the widely-used machine learning framework, sklearn [1].

An alternative approach is to construct the tree level-by-level using another, well-known algorithm, called breadth-first-search (BFS). BFS is enabled by various software packages such as xgboost [2] and has recently been shown to work well when building trees on large datasets in a distributed setting [3].

The following papers form part of the background art:
[1] Fabian Pedregosa et al. Scikit-learn: Machine learning in Python. J. Mach. Learn. Res., 12:2825-2830, November 2011;
[2] Tianqi Chen et al. xgboost: A scalable tree boosting system. SIGKDD KDD '16, ACM, 2016; and
[3] Mathieu Guillame-Bert and Olivier Teytaud. Exact distributed training: Random forest with billions of examples. arXiv:1804.06755 [cs.LG], 2018.

### SUMMARY

According to a first aspect, the present invention is embodied as a computer-implemented method of training a cognitive model. The model involves decision trees as base learners. The method is performed using processing means to which a given cache memory is connected, so as to train the cognitive model based on training examples of a training dataset. More in detail, the cognitive model is trained by running a hybrid tree building algorithm, so as to construct said decision trees and thereby associate the training examples to leaf nodes of the decision trees accordingly constructed. The hybrid tree building algorithm here involves two routines, i.e., a first routine and a second routine. Each routine is designed to access the cache memory upon execution thereof. The first routine involves a breadth-first search tree builder, while the second routine involves a depth-first search tree builder. The hybrid tree building algorithm is designed so as for the routines to execute as follows. For each tree of the decision trees being constructed, the first routine is executed based on a respective selection of the training examples. However, decision can be made, for one or more of the decision trees being constructed, to exit the first routine and execute the second routine if it is determined that a memory size of the cache memory is more conducive to executing the second routine than executing the first routine for said one or more of the decision trees being constructed.

This decision is preferably made based on a criterion involving both the memory size of the cache memory and a number of remaining active examples. The remaining active examples correspond to training examples that are not yet associated with a terminal node of any of the decision trees constructed.

According to another aspect, the invention is embodied as a computerized system, which is configured to train a cognitive model that involves decision trees as base learners. The system notably comprises a primary storage with processing means, a cache memory connected to the processing means, and a main memory that is connected to the cache memory. The system further includes a secondary storage storing computerized methods. The computerized methods as stored on the secondary storage can be at least partly loaded in the main memory of the system. These computerized methods include a hybrid tree building algorithm. The system is configured to train the cognitive model based on training examples of a training dataset by running this hybrid tree building algorithm, so as to construct said decision trees and associate the training examples to leaf nodes of the decision trees accordingly constructed. As noted in reference to the first aspect of the invention, the hybrid tree building algorithm comprises a first routine and a second routine, each designed to access the cache memory upon execution thereof. The first routine involves a breadth-first search tree builder, while the second routine involves a depth-first search tree builder. In operation, for each tree of the decision trees being constructed, the first routine is executed based on a respective selection of the training examples, and decision is made, for one or more of the decision trees being constructed, to exit the first routine and execute the second routine if it is determined that a memory size of the cache memory is more conducive to executing the second routine than executing the first routine for the one or more of the decision trees being constructed.

The system may notably have a parallel, shared-memory multi-threaded configuration; it is preferably configured as a single server.

According to a final aspect, the invention is embodied as a computer program product for training a cognitive model that involves decision trees as base learners, using processing means to which a given cache memory is connected. The computer program product comprise a computer readable storage medium having program instructions embodied therewith. The program instructions are executable by said processing means to cause the latter to perform steps of the method according to the first aspect of the invention.

Computerized systems, methods, and computer program products embodying the present invention will now be described, by way of non-limiting examples, and in reference to the accompanying drawings.

### BRIEF DESCRIPTION OF THE SEVERAL VIEWS OF THE DRAWINGS

The accompanying figures, where like reference numerals refer to identical or functionally similar elements throughout the separate views, and which together with the detailed description below are incorporated in and form part of the present specification, serve to further illustrate various embodiments and to explain various principles and advantages all in accordance with the present disclosure, in which:

FIG. 1 shows diagrams comparing memory access patterns on sorted data, as caused by a BFS tree-builder and a DFS tree-builder, in accordance with an embodiment of the present invention. A toy dataset is considered, which comprises only two features and eight training examples, for simplicity;

FIG. 2 is a flowchart illustrating high-level steps of a method of training a cognitive model that involves decision trees as base learners, in accordance with an embodiment of the present invention; and

FIG. 3 schematically represents a general-purpose computerized system, suited for implementing one or more method steps, in accordance with an embodiment of the present invention.

The accompanying drawings show simplified representations of devices or parts thereof, in accordance with embodiments of the present invention. Similar or functionally similar elements in the figures have been allocated the same numeral references, unless otherwise indicated.

### DETAILED DESCRIPTION

Willing to accelerate the training routine of tree-based ML models, the present Inventors realized that characteristics of the underlying computerized system need be taken into account to design a tree-building algorithm that achieves good performance, in particular when dealing with large datasets and using a large number of trees. The Inventors, accordingly, came to develop system-aware ML methods. In particular, they devised novel hybrid techniques, which combine BFS and DFS processes, so as to take the most out of such methods.

To understand the benefits of such techniques, it is useful to first analyze the memory-access patterns of BFS and DFS.

In the common case when the dataset does not fit in the central processing unit (CPU) cache, accessing the data matrix in a cache-efficient manner helps to achieve better performance. The notion of active example matters to the analysis that follows. An active example can be defined, at a given moment during the execution of the tree-building algorithm, to be any training example that is not yet associated with a terminal node. A key insight is that at each tree depth level, most of the input matrix elements (assuming most examples are still active) are accessed exactly once to compute the best split across the nodes of that depth. A BFS tree-building algorithm, operating across all nodes at the same depth at each step, is thus well suited to access the data matrix in a cache-efficient manner. DFS however is inherently less suited to exploit this property due to it repeatedly going down and up with respect to the tree depth as it builds the tree.

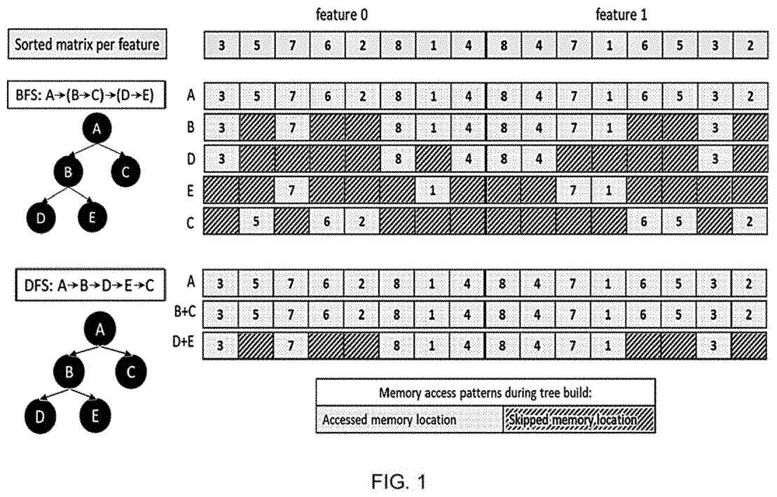

To illustrate the different memory access patterns of BFS and DFS, assume that a tree with five nodes is being built, based on a sorted matrix for a toy dataset with eight examples and two features, as illustrated in FIG. 1. Each item in the sorted matrix contains an example value and a corresponding example index (only the indices are shown in FIG. 1 for simplicity). The expected memory access patterns for each step of the DFS and BFS algorithms are depicted below the sorted matrix; each row reflects an algorithm step; each dotted rectangle depicts an accessed memory location for this step, whereas a striped rectangle denotes a skipped memory location. The example split results in leaf nodes C (examples 2, 5, 6), D (examples 3, 4, 8) and E (examples 1, 7). A DFS variant will start at node A, then proceed to nodes B, D, E, and C. As seen in FIG. 1, such a process gives rise to a large number of skipped memory accesses. In fact, DFS quickly results (with regards to the tree depth) in almost random accesses to the data matrix. On the other hand, a BFS process will start at node A, then proceeds to nodes B, C, D, and E. This approach can be optimized to compute all splits at each depth in one sequential access of the sorted matrix, which results in a cache-efficient memory access pattern to the matrix.

However, as the depth of the tree increases and the number of active examples reduces, BFS no longer maintains a benefit over DFS: they both lead to random accesses to the sorted matrix and exhibit little re-use of cache lines brought to the CPU. In fact, when there are only few active examples left, one can expect the DFS to have better efficiency than BFS, especially if the active part of the sorted matrix (e.g., examples 1, 3, 7, 8, 4 at node B in FIG. 1) fits in the CPU cache, it being noted that the active part may be copied in a packed form to each tree node. DFS is guaranteed to only work with this active set of examples while expanding the tree from said node (e.g., starting at node B, discovering nodes D and E in FIG. 1), thus exhibiting a very good cache behavior.

Based on the above analysis, BFS is more cache-efficient at the first tree levels, as most examples are still active, whereas DFS performs better towards the deepest end, when most examples are inactive. Another reason for starting with a BFS approach is the better cache re-use across trees (as obtained with, e.g., an RF model), assuming the trees are built in parallel: at low tree depths, where most examples are still active, each tree will read the sorted matrix sequentially from shared memory, and overlapping accesses across tree builders are very likely. On the other hand, starting with a DFS approach would only exhibit this benefit at the root node, after which each tree builder will quickly approach a random memory access pattern to the sorted matrix, resulting in dramatically reduced shared cache re-use across builders.

With the above in mind, the Inventors have designed novel techniques, which start with a BFS approach, as explained above. When one no longer expects BFS to be beneficial, the training algorithm switches to a DFS approach. These aspects, as well as other features of the invention, are described in detail in the following.

In reference to FIGS. 1-3, a first aspect of the invention is described, which concerns a computer-implemented method of training a cognitive model that involves decision trees as base learners. The cognitive model may notably be a random forest model, i.e., an ensemble model. However, the techniques described herein may benefit any cognitive model that uses several decision trees.

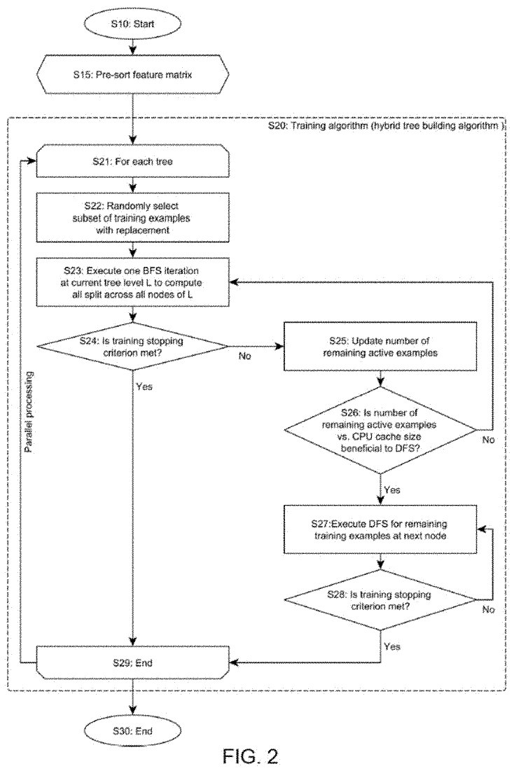

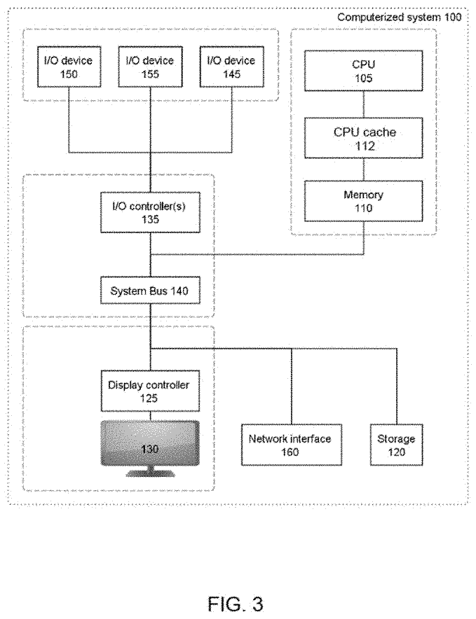

Note, this method and its variants are collectively referred to as the “present methods” in this document. All references “Sij” refer to methods steps of the flowchart of FIG. 2, while numeral references pertain to physical parts or components of the computerized system 100 shown in FIG. 3. The system itself concerns another aspect of the invention, which is described later in this document.

The present methods use processing means 105, to which a given cache memory 112 is connected, see FIG. 3. In practice, the processing means 105 typically correspond to a CPU, to which a CPU cache 112 is associated, as assumed in the following. The CPU cache 112 is a hardware memory cache used by the CPU of the system 100 to reduce the average time/energy cost to access data from the main memory 110. In variants, graphics processing units (GPUs) may be involved, instead of or in addition to CPUs.

Such methods essentially revolve around the training of a cognitive model based on training examples of a training dataset. The training is performed by running S20 a hybrid tree building algorithm, in order to construct the decision trees and thereby associate the training examples to leaf nodes of the decision trees accordingly constructed.

The hybrid tree building algorithm comprises two routines, i.e., a first routine and a second routine, which are, each, designed to access the cache memory 112 upon execution thereof. In particular, the cache 112 may include a data cache, which comprises entries frequently accessed by the routines. The first routine involves a BFS tree builder, while the second routine relies on a DFS tree builder. Such tree builders are known per se. However, they are usually utilized independently of each other in the context of machine learning, as noted in the background section.

On the contrary, the present methods orchestrate BFS and DFS processes, dynamically. Namely, for each tree S21 of the decision trees being constructed, the first routine is initially executed S23-S26 based on a selection S22 of the training examples. For example, each tree is associated to a respective selection of training example.

At some point in the execution of the algorithm, decision will be made to exit (S26: Yes) the first routine and execute S27-S28 the second routine, if a certain condition S26 is met. Note, this decision can be made for one or more of the decision trees that are being constructed, it being noted that such trees are nevertheless preferably constructed in parallel. For example, several such decisions can be made by the algorithm in respect of only one tree or for several of the trees. Such decisions will typically not be made concomitantly but rather at different points in time, this depending on the trees being built and their associated selection of training examples.

The condition used is the following: the algorithm exit the first routine if it is determined S26 that a memory size of the cache memory 112 is more conducive to executing the second routine than executing the first routine and, this, for any decision tree being constructed, or for a subset of the trees, or even all of the trees being constructed.

In other words, running S20 the hybrid tree building algorithm causes, for each decision tree being constructed, to execute the first routine based on a selection of the training examples and, while executing the first routine, evaluate a criterion determining whether a memory size of the cache memory 112 is more amenable to executing the second routine than to the first routine (for said each tree, a subset of the trees, or all of them). If the evaluated criterion happens to be met, the algorithm exits the first routine to execute the second routine, so as to resume the tree building for the trees concerned. In practice, when switching to the second routine, each frontier tree node proceeds with a DFS for its own set of active examples.

Thus, the tree building algorithm can be regarded as a breadth-first, depth-next tree building algorithm. The algorithm is preferably performed in a parallel, shared-memory multi-processing system 100, to allow a parallel training of the model (multiple trees are thus constructed in parallel). For example, the method is preferably performed on a computerized system 100 that is designed in a way that its computing tasks can be assigned to multiple workers of the system. Workers are computerized processes or tasks performed on nodes (computing entities) of the system 100 that are used for the training. That is, a worker basically refers to a process or task that executes part of the training algorithm. A parallel, shared-memory multi-threaded setup is preferred to a distributed setup.

A main benefit of the present approach is to accelerate the training of tree-based machine learning models. For instance, in embodiments, the proposed hybrid tree building algorithm happens to speed up the training of random forest RF models by 7.8× on average when compared to usual RF solvers. Such a figure was obtained by averaging results obtained for a range of datasets, RF configurations, and multi-core CPU architectures.

All this is now described in detail, in reference to particular embodiments of the invention. To start with, the decision to switch routines is preferably made S26 based on a criterion involving both the memory size of the cache memory 112 and a number of remaining active examples. The active examples correspond to training examples that are not yet associated with a terminal node of any of the decision trees being constructed.

Note, the CPU 105 may typically comprise several processing cores. In addition, the system 100 may comprise several processing means 105 (e.g., CPUs or others), and several cache memories, respectively associated with the several processing means. In all cases, the evaluation of the above criterion may be carried out in respect of part of all of the combined cache memory sizes. Several classes of embodiments can accordingly be contemplated, which are discussed below. The criterion used to decide whether to change routines is referred to as a “switch criterion” in the following. This criterion must be distinguished from the stopping criterion (or criteria) used by the algorithm to end the training.

Referring more specifically to FIG. 2, the execution S20 of the hybrid tree building algorithm preferably proceeds as follows. As said, for each tree S21 being constructed, the first routine initially executes S23-S26 based on a respective selection S22 of the training examples. As seen in FIG. 2, the execution of the first routine includes monitoring S25 the number of remaining active examples, by updating this number. For example, if it is determined at step S24 that a chosen stopping criterion is not met yet (S24: No), then the number of remaining active examples is updated S25.

The switch criterion is then evaluated at step S26 by comparing a memory size corresponding to the remaining active examples to the memory size of the cache memory 112 (or a portion thereof) that is allowed for (i.e., imparted to) the active examples of the decision trees being constructed. Next, if the evaluated criterion is met (S26: Yes), the executing algorithm exits the first routine to start executing S27 the second routine and, this, for any of the decision trees being constructed.

If, on the contrary, the switch criterion is found not to be met at step S26 (S26: No), then the first routine resumes and a new BFS iteration is performed S23 (see the loop S23-S24-S25-S26-S23). Thus, when executing the first routine, one or more BFS iterations may typically be performed. The number of active examples is preferably updated at each iteration and for each tree, to ensure a tight monitoring. This way, the BFS iterations are stopped as soon as it is expected to be more beneficial to execute the second routine. In variants, less frequent update steps S25 may be contemplated, which results in a less demanding monitoring process. This allows the execution to somewhat speed up but also results in a less optimal timing for switching routines.

In the example shown in FIG. 2, the first routine is executed until either a training stopping condition is met (S25: Yes) or the switch decision is made (S26: Yes). The second routine too executes until a stopping condition is met (S28: Yes). The conditions used at steps S24 and S28 are likely the same: they normally correspond to the completion of the tree being built. However, additional criteria may possibly be involved at steps S24 and/or S28, e.g., to force stopping the training, if necessary. In all cases, the training ends when conditions evaluated at steps S24, S28 are met.

The method captured in the flowchart of FIG. 2 can be regarded as a hybrid breadth-first, depth-next tree building algorithm for tree-based models, which is advantageously applied to RF models. The depicted algorithm starts with a BFS approach. At each iteration, one monitors the number of active examples that are not associated with a terminal node yet; when the number of active examples becomes so small that one no longer expects the BFS approach to be beneficial, the algorithm switches to a DFS process. Then, each node at the tree frontier proceeds with a DFS search for its own set of active examples. The switching point is chosen, in one example, when all the active data structures fit into the CPU cache size available to each tree builder, as discussed below.

That is, in a first class of embodiments, the switch criterion is independently evaluated S26 for each tree S21 being constructed. There, the memory size of all remaining active examples (pertaining to said each tree) is compared to a respective portion of the memory size of the cache memory 112, i.e., the memory portion that is allowed for said each tree. The first routine is exited (S26: Yes) and the second routine is executed S27 for any tree for which the switch criterion as evaluated at step S26 is met.

Typically, the tree builder workers hold the structure of one decision tree being trained (again, one decision tree is associated to one tree builder) and coordinate the work of the splitters. What is typically compared in that case is the size of active examples and the cache size allowed for each worker. For example, the switch criterion may be written as Size(AE_{wi})≤Size(cache)/N_{w}, where AE_{wi} denotes an active example assigned to worker i, and N_{w} is the total number of workers used for building trees.

In the above example, the method takes into account the dynamic number of workers for deciding when to switch from the BFS to the DFS process. Thus, for different worker counts, different switching points will be decided based on the CPU cache 112 available for each worker, as opposed to a fixed cache capacity per worker.

In a second class of embodiments, switch criteria are evaluated for groups of trees being constructed, in parallel. That is, a switch criterion is evaluated for a set of two or more trees. In this case, the memory size of all active examples pertaining to said set of trees is compared to a portion of the memory size of the cache memory 112 that is allowed for said set of trees. Thus, if a switch criterion is met for a given set of trees, the first routine is exited and the second routine is executed for each tree of said given set. Different memory size thresholds may possibly be used for different sets.

In simpler embodiments, a single switch criterion is used for all trees being built. For example, a single criterion is evaluated for all of the trees being constructed, whereby a memory size of all active examples pertaining to all of said trees is compared to the memory size of the cache memory 112 (or a portion thereof) that is allowed for all the trees being built. As a result, the first routine may be exited and the second routine executed for all of the trees, altogether. What is typically compared in that case are the size of all active examples and the cache size allowed for all of the workers. For example, the switch criterion may be written as Σᵢ Size(AE_{wi})≤Size(cache) in that case. Note, such an approach does not preclude a parallel construction of the trees.

Additional embodiments and variants can be contemplated. For instance, the hybrid tree building algorithm may be designed so as to cause to randomly select S22 one or more training examples, with replacement, to obtain a respective selection of training examples for each tree being constructed, prior to executing S23-S26 the first routine, in order to execute this routine based on said selection.

Moreover, as the inventors noted, searching for the best split consumes the majority of the training time, which suggests additional optimization. A possibility is to pre-sort the training matrix for each feature. While this reduces the complexity of finding the best split at each node, it introduces a one-off overhead: the time required to sort the matrix. Whether this overhead can be amortized depends on the tree depth as well as on the candidate features sampled at each split. If the tree is grown to the point that all of the features have been sampled at least once, then sorting the matrix once in the beginning is more efficient than sorting it at each node. This behavior can be analyzed using a variant of the well-known coupon collector's problem from probability theory. This makes it possible to derive an expression for the probability that all features have been used, and thus the cost of pre-sorting the matrix amortized. Moreover, if the pre-sorted matrix can be used across trees in a forest, its sorting cost is further amortized. To this end, a single read-only version of the sorted matrix can advantageously be maintained in a shared memory, used across all trees for the duration of the training.

Accordingly, the present methods may possibly comprise, prior to running S20 the hybrid tree building algorithm, sorting S15 entries of a data structure (e.g., representable as a matrix) for each vector feature of the training dataset, as assumed in FIG. 2. Step S15 is performed so as to obtain a sorted array of training example values for each vector feature. Then, a single, read-only version of the sorted data structure is stored S15 in memory 110 (a shared memory in this example), so as to be accessed by the first routine and the second routine upon execution thereof. A pre-sorted data structure is accordingly obtained (as also assumed in FIG. 1), which may efficiently be used by the two routines, under certain conditions as noted above. Each routine may advantageously access the sorted entries of the data structure in a sequential manner, e.g., from the shared memory (or the cache memory 112), upon execution thereof. Entries of the data structure are preferably sorted S15 in a multi-threaded fashion. Note, the sorted matrix is not guaranteed to fit in the CPU cache 112; it will typically not in most cases. Thus, it is preferably stored in the shared memory available to all builders.

Referring now more specifically to FIG. 3, another aspect of the invention is described, which concerns a computerized system 100. Consistently with the first aspect of the invention, this system is configured for training a cognitive model that involves decision trees as base learners. Main aspects of the system 100, including the way it works, have been implicitly described in reference to the present methods. Accordingly, the system 100 is only briefly described in the following.

The system includes a primary storage with processing means 105, as well as a cache memory 112 connected to the processing means 105, and a main memory 110, which is connected to the cache memory 112. The system further includes a secondary storage 120 that stores computerized methods, which can be operationalized by the system 100 to perform methods as described in reference to the first aspect of the invention.

The computerized methods notably include a hybrid tree building algorithm, as described earlier, and they can be at least partly loaded in the main memory 110 of the system. As a result, the system 100 is configured to train the cognitive model based on training examples of a training dataset. As described earlier, this is achieved, in operation of the system, by running the hybrid tree building algorithm to construct decision trees and associate the training examples to leaf nodes of the decision trees accordingly constructed.

As already explained, the hybrid tree building algorithm comprises a first routine and a second routine, each designed to access the cache memory 112 upon execution thereof. The routines involve a BFS tree builder and a DFS tree builder, respectively. Executing this algorithm causes, for each tree of the decision trees being constructed, the first routine to execute based on a respective selection of the training examples. In operation, if it is determined that a memory size of the cache memory 112 is more conducive to executing the second routine than executing the first routine, decision may be made to exit the first routine and execute the second routine, for one or more of the decision trees being constructed.

The system 100 preferably has a parallel, shared-memory multi-threaded configuration. It may notably be configured as a single server. Additional aspects of the system 100 are discussed in section 2.1.

A final aspect of the invention concerns a computer program product for training a cognitive model. This program may for instance be run (at least partly) on a computerized unit 100 such as depicted in FIG. 3. This program product comprises a computer readable storage medium having program instructions embodied therewith, which program instructions are executable by one or more processing units (e.g., such as CPU 105 in FIG. 3), to cause the latter to take steps according to the present methods, i.e., train the cognitive model based on training examples by running a hybrid tree building algorithm, whereby execution of the BFS routine may be stopped to execute the DFS routine if the size of the cache memory 112 makes it more favourable. The switch criterion preferably involve both the size of the cache memory 112 and the number of remaining active examples, as explained earlier. Additional aspects of the present computer program products are discussed in detail in sect. 2.2.

The above embodiments have been succinctly described in reference to the accompanying drawings and may accommodate a number of variants. Several combinations of the above features may be contemplated. Examples are given below.

A preferred implementation of the training algorithm starts with a BFS approach, as described earlier. At each BFS step, the active number of examples is monitored; when the number of active examples is so small that one no longer expects BFS to be beneficial, the training algorithm switches to a DFS approach; each node at the tree frontier proceeds with a DFS search for its own set of active examples. The switching point can notably be chosen so as to correspond to the point in time when all the active data structures fit into the CPU cache size available to each tree builder. The switching can be based on a fixed threshold, expressed as a percentage of the number of training examples. If the fraction of active training examples in a given node is less than the specified threshold then the construction of the sub-tree originating from that node is performed using DFS. The higher the threshold, the earlier the tree-building algorithm switches to DFS.

This hybrid algorithm is presented in the algorithm 1 below.

Algorithm 1: Preferred breadth-first, depth-next training algorithm

| | |
|---|---|
| 1: | sort training examples by feature S[1:feature][1:example] |
| 2: | for each tree do |

| | |
|---|---|
| 3: | randomly select a subset of training examples E with |
| | replacement |
| 4: | while (training stopping criteria not met) do |

| | |
|---|---|
| 5: | execute one BFS iteration at current tree level L computing |

all splits across all nodes of L

| | |
|---|---|
| 6: | if (active data CPU cache size beneficial for DFS) do |

| | |
|---|---|
| 7: | break |

| | |
|---|---|
| 8: | while (training stopping criteria not met) do |
| 9: | execute DFS for the remaining training examples at each node |

Preferably, multi-threading is implemented at the tree-level: each tree is trained in parallel on a different CPU core. In addition, the sorting of the data matrix is preferably performed in a multi-threaded fashion too, during initialization.

Further optimization can be contemplated. During the BFS phase, two main modifications can advantageously be performed: (i) the subset of features randomly selected are the same for each node at a particular depth, and (ii) instead of building the tree in a node-to-example manner, the opposite is chosen, whereby, at each tree level the sorted matrix is sequentially walked for all features chosen, maintaining an example-to-node mapping; by the end of this sequential scan, the splits for all nodes have been computed.

With the accesses to the sorted matrix being sequential, the Inventors have profiled the code and identified substantial time being spent in accessing the example-to-node mapping, due to random accesses to it during the BFS phase. This performance issue was alleviated by prefetching the subsequent example-to-node mappings (the indices of which are readily available in the subsequent entries of the sorted matrix). Another possible performance issue may occur in profiling, which concerns the memory accesses to the example label. For binary classification problems, one can exploit the fact that one bit is enough to hold the label information, and pack this into the sorted matrix's example id field (e.g., using bit-fields), effectively stealing one bit from the id without increasing the memory size of the matrix.

For the DFS phase of the algorithm, a packed version of part of the sorted matrix corresponding to the node's active examples can be maintained for each node. At each split, the part of the parent's active examples going to the smaller split is copied to the child that received that split, then the parent's data structured containing the active examples is shrunk to only contain the larger part of the split and re-used for the other child. This optimization reduces the memory allocations (and de-allocations) needed at each DFS step by half compared to a straightforward implementation that allocates two new sub-matrices per split, copies the data over from the parent to the children, and then frees the parent's matrix.

The inventors have studied the performance of the above optimized implementation within the so-called Snap ML framework in single-server environments; it has shown average speed-ups ranging from 2.6× to 33.3× over usual ML framework. The speed-up increases significantly when using larger ensembles.

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, the system depicted in FIG. 3 schematically represents a computerized unit 100, e.g., a general- or specific-purpose computer.

In exemplary embodiments, in terms of hardware architecture, as shown in FIG. 3, the unit 100 includes at least one processor 105, a cache memory 112, and a memory 110 coupled to a memory controller 115. Preferably though, several processors (CPUs, and/or GPUs) are involved, to allow parallelization, as discussed earlier. To that aim, the processing units may be assigned respective memory controllers, as known per se.

One or more input and/or output (I/O) devices 145, 150, 155 (or peripherals) are communicatively coupled via a local input/output controller 135. The I/O controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor(s) 105 is (are) a hardware device for executing software, particularly that initially stored in memory 110. The processor(s) 105 can be any custom made or commercially available processor(s), may include one or more central processing units (CPUs) and/or one or more graphics processing units (GPUs), or, still, have an architecture involving auxiliary processors among several processors associated with the computer 100. In general, it may involve any type of semiconductor-based microprocessor (in the form of a microchip or chip set), or generally any device for executing software instructions.

The memory 110 can include any one or combination of volatile memory elements (e.g., random access memory) and nonvolatile memory elements. Moreover, the memory 110 may incorporate electronic, magnetic, optical, and/or other types of storage media. Note that the memory 110 can have a distributed architecture, where various components are situated remote from one another, but can be accessed by the processor(s) 105.

The software in memory 110 may include one or more separate programs, each of which comprises an ordered listing of executable instructions for implementing logical functions. In the example of FIG. 3, the software in the memory 110 includes computerized methods, forming part of all of the methods described herein in accordance with exemplary embodiments and, in particular, a suitable operating system (OS). The OS essentially controls the execution of other computer programs and provides scheduling, input-output control, file and data management, memory management, and communication control and related services.

The methods described herein (or part thereof) may be in the form of a source program, executable program (object code), script, or any other entity comprising a set of instructions to be performed. When in a source program form, then the program needs to be translated via a compiler, assembler, interpreter, or the like, as known per se, which may or may not be included within the memory 110, so as to operate properly in connection with the OS. Furthermore, the methods can be written as an object-oriented programming language, which has classes of data and methods, or a procedure programming language, which has routines, subroutines, and/or functions.

Possibly, a conventional keyboard and mouse can be coupled to the input/output controller 135. Other I/O devices 140-155 may be included. The computerized unit 100 can further include a display controller 125 coupled to a display 130. In exemplary embodiments, the computerized unit 100 can further include a network interface or transceiver 160 for coupling to a network, to enable, in turn, data communication to/from other, external components.

The network transmits and receives data between the unit 100 and external devices. The network is possibly implemented in a wireless fashion, e.g., using wireless protocols and technologies, such as Wifi, WiMax, etc. The network may be a fixed wireless network, a wireless local area network (LAN), a wireless wide area network (WAN) a personal area network (PAN), a virtual private network (VPN), intranet or other suitable network system and includes equipment for receiving and transmitting signals.

The network can also be an IP-based network for communication between the unit 100 and any external server, client and the like via a broadband connection. In exemplary embodiments, network can be a managed IP network administered by a service provider. Besides, the network can be a packet-switched network such as a LAN, WAN, Internet network, an Internet of things network, etc.

If the unit 100 is a PC, workstation, intelligent device or the like, the software in the memory 110 may further include a basic input output system (BIOS). The BIOS is stored in ROM so that the BIOS can be executed when the computer 100 is activated. When the unit 100 is in operation, the processor(s) 105 is(are) configured to execute software stored within the memory 110, to communicate data to and from the memory 110, and to generally control operations of the computer 100 pursuant to the software.

The methods described herein and the OS, in whole or in part are read by the processor(s) 105, typically buffered within the processor(s) 105, and then executed. When the methods described herein are implemented in software, the methods can be stored on any computer readable medium, such as storage 120, for use by or in connection with any computer related system or method.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to a limited number of embodiments, variants and the accompanying drawings, it will be understood by those skilled in the art that various changes may be made and equivalents may be substituted without departing from the scope of the present invention. In particular, a feature recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method of training a cognitive model that includes decision trees as base learners, using processing means to which a cache memory is connected, wherein the method comprises:
training the cognitive model based on training examples of a training dataset by running a hybrid tree building algorithm to construct the decision trees and associate the training examples to leaf nodes of the constructed decision trees, respectively, wherein:
the hybrid tree building algorithm comprises a first routine and a second routine, wherein the first routine and the second routine are designed to access the cache memory upon execution; and
the first routine involves a breadth-first search tree builder and the second routine involves a depth-first search tree builder, whereby:
for each tree of the decision trees being constructed, the first routine is executed based on a respective selection of the training examples, and
decision is made, for one or more of the decision trees being constructed, to exit the first routine and execute the second routine if it is determined that a memory size of the cache memory is more conducive to executing the second routine than executing the first routine for the one or more of the decision trees being constructed.

2. The method according to claim 1, wherein:
the decision is made based on a criterion involving both the memory size of the cache memory and a number of remaining active examples, wherein the number of remaining active examples correspond to the training examples that are not yet associated with a terminal node of any of the constructed decision trees.

3. The method according to claim 2, wherein running the hybrid tree building algorithm further comprises:
for each tree of the decision trees being constructed, executing the first routine based on the respective selection of the training examples, including monitoring the number of remaining active examples;
while executing the first routine, evaluating the criterion by comparing a memory size of the number of remaining active examples to a portion of the memory size of the cache memory as allowed for the number of remaining active examples of the one or more of the decision trees being constructed; and
if the evaluated criterion is met, exiting the first routine and executing the second routine for the one or more of the decision trees being constructed.

4. The method according to claim 3, wherein:
the criterion is independently evaluated for each tree of the decision trees being constructed, whereby a memory size of the number of remaining active examples pertaining to each tree is compared to the portion of the memory size of the cache memory as allowed for each tree of the decision trees, and wherein the first routine is exited and the second routine is executed for any tree, of the decision trees, for which the evaluated criterion is met.

5. The method according to claim 3, wherein:
the criterion is evaluated for a set of two or more decision trees being constructed, whereby a memory size of all active examples, pertaining to the set of two or more decision trees being constructed, is compared to a portion of the memory size of the cache memory allowed for the set, and wherein the first routine is exited and the second routine is executed for each tree of the set.

6. The method according to claim 5, wherein:
the criterion is evaluated for all of the trees of the decision trees being constructed, whereby a memory size of all active examples, pertaining to all of the trees of the decision trees being constructed, is compared to a portion of the memory size of the cache memory allowed for all of the trees of the decision trees being constructed, and wherein the first routine is exited and the second routine is executed for all of the trees of the decision trees being constructed.

7. The method according to claim 3, wherein running the hybrid tree building algorithm further comprises:
for each tree of the decision trees being constructed, randomly selecting one or more of the training examples with a replacement to obtain a respective selection of the one or more of the training examples, in order to execute the first routine based on the respective selection.

8. The method according to claim 1, further comprising:
for each vector feature of the training dataset, sorting entries of a data structure to obtain, for each vector feature, a sorted array of training example values, prior to running the hybrid tree building algorithm; and
a single, read-only version of the sorted data structure is stored in the cache memory, and accessed by the first routine and the second routine upon execution.

9. The method according to claim 8, wherein
the entries of the data structure are sorted in a multi-threaded fashion.

10. The method according to claim 8, wherein:
each of the first routine and the second routine accesses the sorted entries of the data structure in a sequential manner from the cache memory, upon execution.

11. The method according to claim 1, wherein:
the first routine is executed until either a training stopping condition is met or the decision is made.

12. The method according to claim 1, wherein:
the cognitive model is a random forest model.

13. The method according to claim 1, wherein:
the method is performed in a parallel, shared-memory multi-threaded setup, so as to construct multiple ones of the decision trees in parallel.

14. A computerized system for training a cognitive model that includes decision trees as base learners, the system comprising:
a primary storage with processing means, a cache memory connected to the processing means, and a main memory, connected to the cache memory; and
a secondary storage storing computerized methods that include a hybrid tree building algorithm, wherein:
the computerized methods can be at least partly loaded in the main memory, whereby the system is configured to train the cognitive model based on training examples of a training dataset by running the hybrid tree building algorithm to construct the decision trees and associate the training examples to leaf nodes of the constructed decision trees, respectively, wherein;
the hybrid tree building algorithm comprises a first routine and a second routine, wherein the first routine and the second routine are designed to access the cache memory upon execution; and
the first routine involves a breadth-first search tree builder and the second routine involves a depth-first search tree builder, whereby, in operation;
for each tree of the decision trees being constructed, the first routine is executed based on a respective selection of the training examples; and
decision is made, for one or more of the decision trees being constructed, to exit the first routine and execute the second routine if it is determined that a memory size of the cache memory is more conducive to executing the second routine than executing the first routine for the one or more of the decision trees being constructed.

15. The computerized system according to claim 14, wherein:
the system has a parallel, shared-memory multi-threaded configuration.

16. The computerized system according to claim 14, wherein:
the system is configured as a single server.

17. A computer program product for training a cognitive model that includes decision trees as base learners, using processing means to which a given cache memory is connected, the computer program product comprising a computer readable storage medium having program instructions embodied therewith, the program instructions executable by said processing means to cause the latter to:
train the cognitive model based on training examples of a training dataset by running a hybrid tree building algorithm to construct the decision trees and associate the training examples to leaf nodes of the constructed decision trees, respectively; wherein
the hybrid tree building algorithm comprises a first routine and a second routine, wherein the first routine and the second routine are designed to access the cache memory upon execution; and
the first routine involves a breadth-first search tree builder and the second routine involves a depth-first search tree builder, whereby, in operation;
for each tree of the decision trees being constructed, the first routine is executed based on a respective selection of the training examples; and
decision is made, for one or more of the decision trees being constructed, to exit the first routine and execute the second routine if it is determined that a memory size of the cache memory is more conducive to executing the second routine than executing the first routine for the one or more of the decision trees being constructed.

18. The computer program product according to claim 17, wherein:
the program instructions are further designed for the decision to be made based on a criterion involving both the memory size of the cache memory and a number of remaining active examples, wherein the number of remaining active examples correspond to the training examples that are not yet associated with a terminal node of any of the constructed decision trees, in operation.

19. The computer program product according to claim 18, wherein running the hybrid tree building algorithm further comprises:
for each tree of the decision trees being constructed, executing the first routine based on the respective selection of the training examples, including monitoring the number of remaining active examples;
while executing the first routine, evaluating the criterion by comparing a memory size of the number of remaining active examples to a portion of the memory size of the cache memory as allowed for the number of remaining active examples of the one or more of the decision trees being constructed; and
if the evaluated criterion is met, exiting the first routine and executing the second routine for the one or more of the decision trees being constructed.

20. The computer program product according to claim 19, wherein:
the criterion is independently evaluated for each tree of the decision trees being constructed, whereby a memory size of the number of remaining active examples pertaining to each tree is compared to the portion of the memory size of the cache memory as allowed for each tree of the decision trees, and wherein the first routine is exited and the second routine is executed for any tree, of the decision trees, for which the evaluated criterion is met.
